(19) United States
(12) Patent Application Publication
(10) Pub. No.: US 2026/0360639 A1
(43) Pub. Date: Nov. 12, 2026

(54) ELECTRIC SWITCH

(71) Applicant: ABB Schweiz AG, Baden (CH)

(72) Inventors: Jarmo Lehtimäki, Vaasa (FI); Markus Mäki, Vaasa (FI)

(21) Appl. No.: 19/658,950

(22) Filed: Apr. 27, 2026

(30) Foreign Application Priority Data
May 9, 2025 (EP) 25175286.1

(51) Int. Cl. H01H 33/06

(52) U.S. Cl. CPC H01H 33/06

(57) ABSTRACT

An electric switch comprising a frame, a first stationary contact, a roll element rotatable around a rotation axis, a rotating contact stationarily fixed to the roll element, and an arc shutter system comprising a first arc shutter rotatable about a first shutter axis, and a second arc shutter rotatable about a second shutter axis. In a first direction perpendicular to the rotation axis, the second shutter axis is located between the first shutter axis and the rotation axis, wherein the second arc shutter is adapted to cooperate with the first arc shutter in order to enhance extinguishing of the electric arc during an opening event of the electric switch, and wherein the first arc shutter and the second arc shutter are adapted to rotate in the same direction.

### CROSS-REFERENCE TO RELATED APPLICATIONS

This application claims priority to European Patent Application No. 25175286.1, filed May 9, 2025 and titled “ELECTRIC SWITCH”, the entire contents of which are hereby incorporated by reference.

### TECHNICAL FIELD

The present disclosure relates to an electric switch, and more particularly to an electric switch comprising an arc shutter system having a rotatable arc shutter.

### BACKGROUND

An electric switch is a device adapted to open and close an electric circuit. When an electric circuit is opened by an electric switch, an electric arc whose temperature is thousands of degrees may occur in the electric switch. An electric arc includes ionized gas, which contains a large number of free electrons. Such a gas plasma is electrically conductive.

An electric arc delays transfer of an electric switch from a conducting state to a non-conducting state. Further, an electric arc is often harmful for an electric switch and for an electric assembly comprising the electric switch.

It is known in the art to use an arc shutter system to enhance extinguishing of an electric arc during an opening event of an electric switch. An example of an electric switch comprising an arc shutter system having a rotatable arc shutter is described in publication US2020/0098530.

### BRIEF DESCRIPTION

An object of the present disclosure is to provide an electric switch with an improved arc shutter system.

The objects of the disclosure are achieved by an electric switch which is described as follows.

The disclosure is based on the idea of providing an arc shutter system comprising two rotatable arc shutters adapted to cooperate with each other in order to enhance extinguishing of the electric arc by lengthening the electric arc during the opening event.

An advantage of the electric switch of the disclosure is that due to the arc shutter system comprising two rotatable arc shutters, good breaking capacity is achieved in compact size.

### BRIEF DESCRIPTION OF THE DRAWINGS

In the following the disclosure will be described in greater detail by means of various embodiments with reference to the attached drawings.

FIG. 1 shows a switch assembly comprising two electric switches according to an embodiment of the disclosure.

FIG. 2 shows an exploded view of one of the electric switches shown in FIG. 1.

FIGS. 3A, 3B and 3C show cross-sectional side views of the electric switch of FIG. 2 in different operational states.

FIGS. 4A, 4B and 4C show axonometric projections of an operating mechanism of the electric switch of FIG. 2 in different operational states.

### DETAILED DESCRIPTION

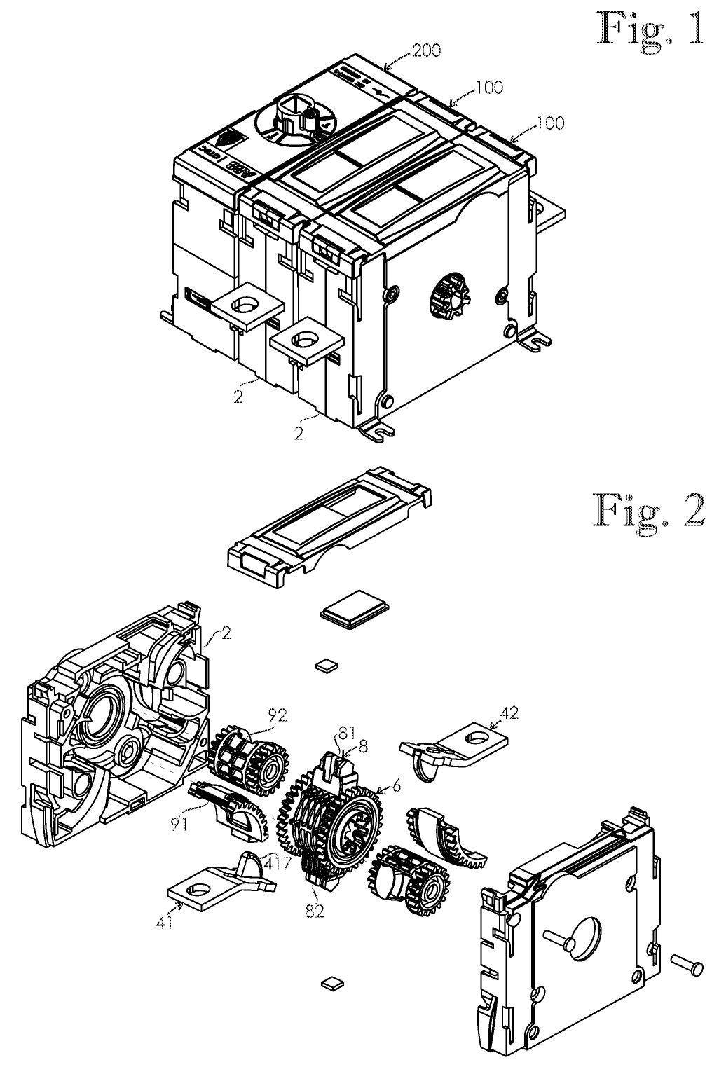

FIG. 1 shows a switch assembly comprising two electric switches 100 according to an embodiment of the disclosure, and a control module 200 adapted to control the electric switches.

FIG. 2 shows an exploded view of one of the electric switches 100. The electric switch 100 comprises a frame 2, a first stationary contact 41, a second stationary contact 42, a roll element 6, a rotating contact 8, an arc shutter system and a transmission mechanism.

The first stationary contact 41 is stationarily fixed to the frame 2 and is adapted to be connected to a power supply. The second stationary contact 42 is stationarily fixed to the frame 2 and is adapted to be connected to a load. The roll element 6 is adapted to rotate relative to the frame 2 around a rotation axis between a first position and second position. Both axial ends of the roll element 6 are accessible from outside the frame 2.

The rotating contact 8 is stationarily fixed to the roll element 6, and comprises a first contact portion 81 and a second contact portion 82. In the first position of the roll element 6, the first contact portion 81 is electrically conductively connected to the first stationary contact 41, and the second contact portion 82 is electrically conductively connected to the second stationary contact 42 such that the first stationary contact 41 and the second stationary contact 42 are electrically conductively connected to each other. In the second position of the roll element 6, the rotating contact 8 is disconnected from the first stationary contact 41 and the second stationary contact 42.

The first stationary contact 41 and the first contact portion 81 of the rotating contact 8 are adapted to cooperate as knife contacts. Similarly, the second stationary contact 42 and the second contact portion 82 of the rotating contact 8 are adapted to cooperate as knife contacts.

The arc shutter system is adapted to enhance extinguishing of electric arcs between the first stationary contact 41 and the first contact portion 81 and between the second stationary contact 42 and the second contact portion 82 during an opening event of the electric switch. For the electric arc between the first stationary contact 41 and the first contact portion 81, the arc shutter system comprises a first arc shutter 91, a second arc shutter 92 and a counterpart member. Further, the arc shutter system comprises corresponding components for the electric arc between the second stationary contact 42 and the second contact portion 82, but they are not discussed in detail herein since their shape and operation are identical to the shape and operation of the components adapted for extinguishing electric arc between the first stationary contact 41 and the first contact portion 81. Components of the arc shutter system are made of electrically insulating material or materials.

The first arc shutter 91 is rotatable relative to the frame 2 about a first shutter axis between a first position and a second position, wherein the first shutter axis is spaced apart from the rotation axis of the roll element 6. The second arc shutter 92 is rotatable relative to the frame 2 about a second shutter axis between a first position and a second position, and is adapted to cooperate with the first arc shutter 91 in order to enhance extinguishing of the electric arc by lengthening the electric arc during the opening event. The first arc shutter 91 and the second arc shutter 92 lengthen the electric arc by blocking the shortest route between the first stationary contact 41 and the first contact portion 81 of the rotating contact 8, thereby forcing the electric arc to use a longer route.

The first shutter axis and the second shutter axis are parallel to the rotation axis of the roll element 6. The counterpart member is stationary relative to the frame 2 and is adapted to cooperate with the first arc shutter 91 in order to enhance extinguishing of the electric arc by squeezing the electric arc between the first arc shutter 91 and the counterpart member.

The first arc shutter 91 and the second arc shutter 92 are adapted to rotate in the same direction. The rotation direction of the first arc shutter 91 and the second arc shutter 92 is opposite to the rotation direction of the roll element 6.

The second arc shutter 92 is adapted to rotate at a greater angular velocity than the roll element 6. Further, the second arc shutter 92 is adapted to rotate at a greater angular velocity than the first arc shutter 91.

The transmission mechanism is adapted for transferring power from the roll element 6 to the first arc shutter 91 and the second arc shutter 92. Rotation of the roll element 6 is adapted to rotate the first arc shutter 91 and the second arc shutter 92 relative to the frame 2 such that rotation of the roll element 6 from the first position to the second position rotates the first arc shutter 91 and the second arc shutter 92 from their first positions to their second positions.

The transmission mechanism comprises a plurality of roll teeth stationarily connected relative to the roll element 6, a plurality of first teeth stationarily connected relative to the first arc shutter 91, and a plurality of second teeth stationarily connected relative to the second arc shutter 92. The roll teeth are adapted to be in contact with the first teeth and the second teeth for transferring power from the roll element 6 to the first arc shutter 91 and the second arc shutter 92.

The first arc shutter 91 has a form of a sector of a right circular hollow cylinder such that a ratio between an inner radius and an external radius of the sector is greater than or equal to 80 %. The axis of the sector of the right circular hollow cylinder coincides with the first shutter axis. In an alternative embodiment, the first arc shutter has a form of a sector of a right circular hollow cylinder such that a ratio between an inner radius and an external radius of the sector is greater than or equal to 60 %.

A radial dimension of the first arc shutter 91 is approximately 230% of a radial dimension of the second arc shutter 92. Further, the radial dimension of the first arc shutter 91 is greater than a radial dimension of the roll element 6. In an alternative embodiment, a radial dimension of the first arc shutter is greater than or equal to 150% of a radial dimension of the second arc shutter. Herein, a radial dimension of a rotatable component is a distance between a rotation axis of the rotatable component and an outer surface of the rotatable component facing away from the rotation axis.

In a first peripheral direction, the first arc shutter 91 extends between a first end and a second end such that an angle between the first end and the second end is approximately 80°. In an alternative embodiment, the first arc shutter extends in the first peripheral direction between a first end and a second end such that an angle between the first end and the second end is greater than or equal to 45°. The first peripheral direction is a tangential direction relative to the first shutter axis.

In a second peripheral direction, the second arc shutter 92 extends between a first end and a second end such that an angle between the first end and the second end is approximately 115°. In an alternative embodiment, the second arc shutter extends in the second peripheral direction between a first end and a second end such that an angle between the first end and the second end is greater than or equal to 45°. The second peripheral direction is a tangential direction relative to the second shutter axis.

Lateral dimensions of the first arc shutter 91 and the second arc shutter 92 are greater than a lateral dimension of the first contact portion 81 and greater than a lateral dimension of an arc section 417 of the first stationary contact 41. The arc section 417 is a section of the first stationary contact 41 on which an end of the electric arc is located during the opening event. The lateral dimensions are parallel to the rotation axis of the roll element 6.

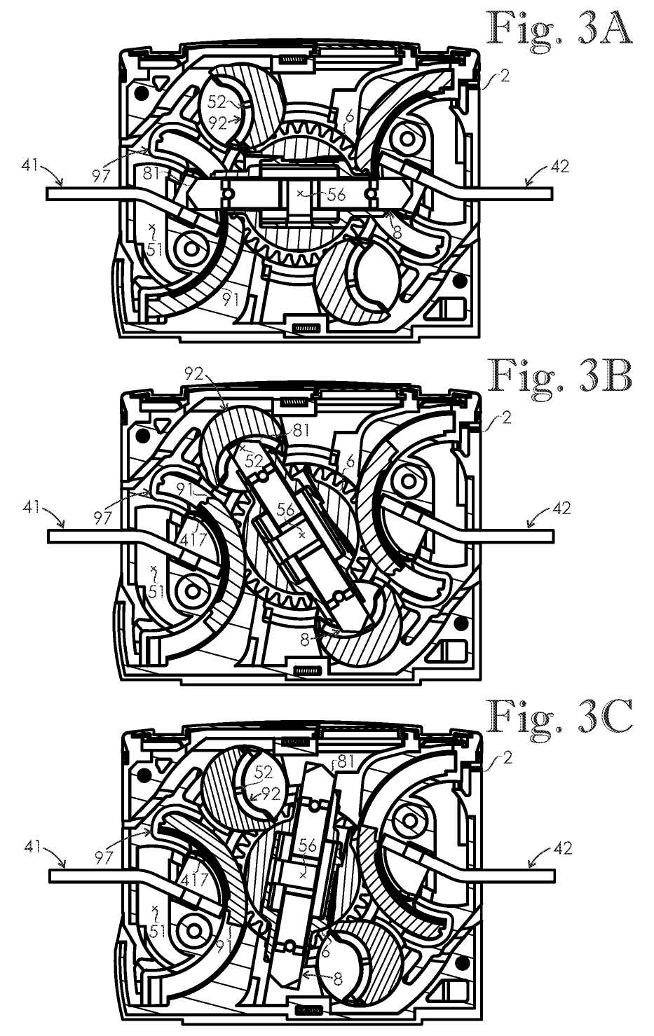

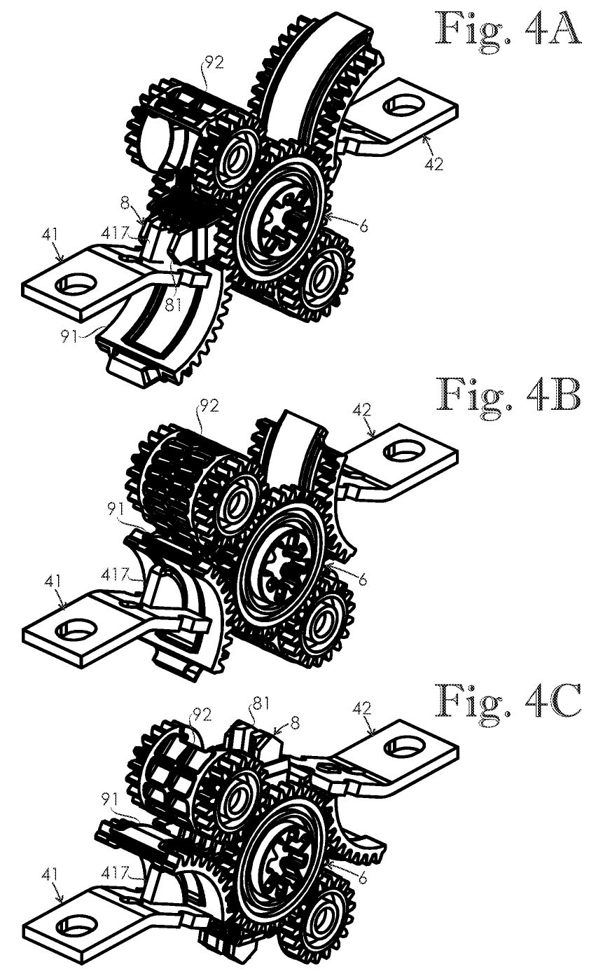

FIGS. 3A, 3B and 3C show cross-sectional side views of the electric switch 100 in different operational states. FIGS. 4A, 4B and 4C show axonometric projections of an operating mechanism of the electric switch 100 in different operational states. The operational states shown in FIGS. 3A, 3B and 3C correspond to the operational states shown in FIGS. 4A, 4B and 4C. In FIGS. 4A, 4B and 4C, the frame 2 of the electric switch 100 has been omitted.

In FIG. 3A, the electric switch 100 is in an ON state, and the roll element 6, the first arc shutter 91 and the second arc shutter 92 are in their first positions. In FIG. 3B, the electric switch 100 is in an intermediate state between the ON state and an OFF state, and the roll element 6, the first arc shutter 91 and the second arc shutter 92 are in their intermediate positions between their first and second positions. In FIG. 3C, the electric switch 100 is in the OFF state, and the roll element 6, the first arc shutter 91 and the second arc shutter 92 are in their second positions.

In FIGS. 3A, 3B and 3C, the rotation axis of the roll element 6 is denoted with reference sign 56, the first shutter axis is denoted with reference sign 51, and the second shutter axis is denoted with reference sign 52. Image planes of FIGS. 3A, 3B and 3C are perpendicular to the rotation axis 56, the first shutter axis 51 and the second shutter axis 52.

A rotational angle between the first position and the second position of the roll element 6 is approximately 110°. In an embodiment, a rotational angle between the first position and the second position of the roll element is less than or equal to 140°.

In a first direction perpendicular to the rotation axis 56, the second shutter axis 52 is located between the first shutter axis 51 and the rotation axis 56. In the first direction, the arc section 417 of the first stationary contact 41 is located between the first shutter axis 51 and the rotation axis 56, and a distance between the first shutter axis 51 and the second shutter axis 52 is greater than a distance between the rotation axis 56 and the second shutter axis 52. The arc section 417 is a section of the first stationary contact 41 on which an end of the electric arc is located during the opening event. The first stationary contact 41 and the second stationary contact 42 are accessible outside the frame 2 such that in the first direction, the accessible portions of the first stationary contact 41 and the second stationary contact 42 are on opposite sides of the frame 2. In FIGS. 3A, 3B and 3C, the first direction is horizontal direction.

In a second direction perpendicular to both the rotation axis 56 and the first direction, the rotation axis 56 is located between the first shutter axis 51 and the second shutter axis 52, and the arc section 417 of the first stationary contact 41 is located between the first shutter axis 51 and the second shutter axis 52. In FIGS. 3A, 3B and 3C, the second direction is vertical direction.

An outer surface of the arc section 417 of the first stationary contact 41 has a convex shape and an inner surface of the first arc shutter 91 facing the first shutter axis 51 has a concave shape. In an intermediate position of the roll element 6 between the first position and the second position, the convex outer surface of the arc section 417 faces the concave inner surface of the first arc shutter 91. The intermediate position of the roll element 6 corresponds to the intermediate state of the electric switch shown in FIG. 3B.

In an embodiment, in the intermediate position of the roll element, a distance between the convex outer surface of the arc section and the concave inner surface of the first arc shutter is less than or equal to 2.0 mm. In another embodiment, in the intermediate position of the roll element, a distance between the convex outer surface of the arc section and the concave inner surface of the first arc shutter is less than or equal to 5.0 mm.

During the opening event, a leading edge of the first arc shutter 91 passes a leading edge of the second arc shutter 92. Such a passing event is shown in FIG. 3B. In an embodiment, during said passing event, the shortest distance between the leading edge of the first arc shutter 91 and the leading edge of the second arc shutter 92 is less than or equal to 10 mm.

A distance between the rotation axis 56 and a free end of the first contact portion 81 is greater than a distance obtainable by subtracting the radial dimension of the second arc shutter 92 from a distance between the rotation axis 56 and the second shutter axis 52. A distance between the rotation axis 56 and the second shutter axis 52 is smaller than or equal to a distance between the rotation axis 56 and the free end of the first contact portion 81.

In the intermediate state of the electric switch shown in FIG. 3B, a convex side of the first arc shutter 91 and a concave side of the second arc shutter 92 are facing the rotation axis 56 of the roll element 6. In the intermediate state, a distance between the concave side of the second arc shutter 92 and the first contact portion 81 is less than or equal to 2.0 mm.

During the opening event, the second arc shutter 92 is adapted to cooperate with the roll element 6 in order to enhance extinguishing of the electric arc by squeezing the electric arc between the second arc shutter 92 and the roll element 6. In the OFF state of the electric switch 100, in which the second arc shutter 92 is in the second position, a distance between the second arc shutter 92 and the roll element 6 is less than or equal to 1.5 mm. In another embodiment, in the second position of the second arc shutter, a distance between the second arc shutter and the roll element is less than or equal to 2.5 mm.

Referring to FIGS. 3A, 3B and 3C, the counterpart member 97 of the arc shutter system comprises a receiving section adapted to receive a portion of the first arc shutter 91 in the second position of the first arc shutter 91. In the second position of the first arc shutter 91, the receiving section together with the portion of the first arc shutter 91 form a first squeezed path for the electric arc.

In an embodiment, in the first squeezed path, a distance between the first arc shutter and the counterpart member of the arc shutter system is less than or equal to 2.0 mm. In another embodiment, in the first squeezed path, a distance between the first arc shutter and the counterpart member of the arc shutter system is less than or equal to 1.5 mm.

A length of the first squeezed path is greater than or equal to 5 mm.

In another embodiment, a length of the first squeezed path is greater than or equal to 10 mm. The length of the first squeezed path is formed by one or more sections.

Referring to FIG. 3C, the first squeezed path has three sections, a first section between the concave inner surface of the first arc shutter 91 and a first inner surface of the receiving section, a second section between an end surface of the first arc shutter 91 and a second inner surface of the receiving section, and a third section between the convex outer surface of the first arc shutter 91 and a third inner surface of the receiving section. The end surface of the first arc shutter 91 is facing a tangential direction relative to the first shutter axis. The second inner surface of the receiving section is an inner bottom surface of the receiving section.

In the second position of the first arc shutter 91, the first arc shutter 91 is in contact with the counterpart member 97 such that a route of the electric arc is closed. In other words, the end surface of the first arc shutter 91 is in contact with the inner bottom surface of the receiving section. In an embodiment, the end surface of the first arc shutter and/or the inner bottom surface of the receiving section is made of elastic material.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An electric switch comprising:
a frame;
a first stationary contact stationarily fixed to the frame;
a roll element rotatable relative to the frame about a rotation axis between a first position and a second position;
a rotating contact stationarily fixed to the roll element, and comprising a first contact portion such that in the first position of the roll element the first contact portion is electrically conductively connected to the first stationary contact, and in the second position of the roll element the rotating contact is disconnected from the first stationary contact; and
an arc shutter system configured to enhance extinguishing of an electric arc between the first stationary contact and the first contact portion of the rotating contact during an opening event of the electric switch, wherein the arc shutter system comprises a first arc shutter rotatable relative to the frame about a first shutter axis between a first position and a second position, and wherein the first shutter axis is spaced apart from the rotation axis ,
wherein the arc shutter system comprises a second arc shutter rotatable relative to the frame around a second shutter axis between a first position and a second position, wherein in a first direction perpendicular to the rotation axis, the second shutter axis is located between the first shutter axis and the rotation axis, wherein the second arc shutter is configured to cooperate with the first arc shutter to enhance extinguishing of the electric arc by lengthening the electric arc during the opening event, and wherein the first arc shutter and the second arc shutter are configured to rotate in a same direction.

2. The electric switch as claimed in claim 1, wherein in the first direction, an arc section of the first stationary contact is located between the first shutter axis and the rotation axis, and wherein the arc section is a section of the first stationary contact on which an end of the electric arc is located during the opening event.

3. The electric switch as claimed in claim 1 wherein a first radial dimension of the first arc shutter is greater than or equal to 150% of a second radial dimension of the second arc shutter, and wherein the radial dimension is a distance between the shutter axis and an outer surface of the arc shutter facing away from the shutter axis.

4. The electric switch as claimed in claim 1, wherein a distance between the rotation axis and a free end of the first contact portion is greater than a distance obtainable by subtracting a radial dimension of the second arc shutter from a distance between the rotation axis and the second shutter axis, and wherein the radial dimension of the second arc shutter is a distance between the second shutter axis] and an outer surface of the second arc shutter facing away from the second shutter axis.

5. The electric switch as claimed in claim 1, wherein the electric switch comprises a transmission mechanism for transferring power from the roll element to the first arc shutter and the second arc shutter such that rotation of the roll element rotates the first arc shutter and the second arc shutter relative to the frame.

6. The electric switch as claimed in claim 5, wherein the transmission mechanism comprises a plurality of roll teeth stationarily connected relative to the roll element, a plurality of first teeth stationarily connected relative to the first arc shutter, and a plurality of second teeth stationarily connected relative to the second arc shutter.

7. The electric switch as claimed in claim 1, wherein the first arc shutter has a form of a sector of a right circular hollow cylinder such that a ratio between an inner radius and an external radius of the sector is greater than or equal to 60 %.

8. The electric switch as claimed in claim 1, wherein the first arc shutter has a convex side and the second arc shutter has concave side such that in an intermediate position of the a roll element between the first position and the second position, the convex side of the first arc shutter and the concave side of the second arc shutter are facing the rotation axis of the roll element.

9. The electric switch as claimed in claim 1, wherein the arc shutter system comprises a counterpart member configured to cooperate with the first arc shutter to enhance extinguishing of the electric arc by squeezing the electric arc between the first arc shutter and the counterpart member, and wherein the counterpart member is stationary relative to the frame.

10. The electric switch as claimed in claim 9, wherein the counterpart member comprises a receiving section configured to receive at least a portion of the first arc shutter in the second position of the first arc shutter, wherein in the second position of the first arc shutter, the receiving section together with the at least a portion of the first arc shutter form a first squeezed path for the electric arc, and wherein in the first squeezed path, a distance between the first arc shutter and the counterpart member is less than or equal to 1.5 mm.

11. The electric switch as claimed in claim 10, wherein a length of the first squeezed path is greater than or equal to 10 mm.

12. The electric switch as claimed in claim 1, wherein the second arc shutter is configured to cooperate with the roll element to enhance extinguishing of the electric arc by squeezing the electric arc between the second arc shutter and the roll element.

13. The electric switch as claimed in claim 12, wherein in the second position of the second arc shutter, a distance between the second arc shutter and the roll element is less than or equal to 2.5 mm.

14. The electric switch as claimed in claim 1, wherein the first stationary contact and the first contact portion of the rotating contact are configured to cooperate as knife contacts.

15. The electric switch as claimed in claim 14, wherein an outer surface of an arc section of the first stationary contact has a convex shape and an inner surface of the first arc shutter facing the first shutter axis has a concave shape such that in an intermediate position of the a roll element between the first position and the second position, a convex outer surface of the arc section faces a concave inner surface of the first arc shutter, and wherein the arc section is a section of the first stationary contact on which an end of the electric arc is located during the opening event.

16. The electric switch as claimed in claim 2, wherein a radial dimension of the first arc shutter is greater than or equal to 150% of a radial dimension of the second arc shutter, and wherein the radial dimension is a distance between the shutter axis and an outer surface of the arc shutter facing away from the shutter axis.

17. The electric switch as claimed in claim 2, wherein a distance between the rotation axis and a free end of the first contact portion is greater than a distance obtainable by subtracting a radial dimension of the second arc shutter from a distance between the rotation axis and the second shutter axis, and wherein the radial dimension of the second arc shutter is a distance between the second shutter axis and an outer surface of the second arc shutter facing away from the second shutter axis.

18. The electric switch as claimed in claim 3, wherein a distance between the rotation axis and a free end of the first contact portion is greater than a distance obtainable by subtracting a radial dimension of the second arc shutter from a distance between the rotation axis and the second shutter axis, and wherein the radial dimension of the second arc shutter is a distance between the second shutter axis and an outer surface of the second arc shutter facing away from the second shutter axis.

19. The electric switch as claimed in claim 2, wherein the electric switch comprises a transmission mechanism for transferring power from the roll element to the first arc shutter and the second arc shutter such that rotation of the roll element rotates the first arc shutter and the second arc shutter relative to the frame.

20. The electric switch as claimed in claim 3, wherein the electric switch comprises a transmission mechanism for transferring power from the roll element to the first arc shutter and the second arc shutter such that rotation of the roll element rotates the first arc shutter and the second arc shutter relative to the frame.
